(19) United States
(12) Patent Application Publication
(10) Pub. No.: US 2009/0087259 A1
(43) Pub. Date: Apr. 2, 2009

(54) Robust Hybrid Structural Joints

(76) Inventor: David S. Bettinger, Grosse Ile, MI (US)

Correspondence Address: DAVID S. BETTINGER, 8030 COVENTRY, GROSSE ILE, MI, 48138, US

(21) Appl. No.: 12/238,540

(22) Filed: Sep. 26, 2008

Related U.S. Application Data
(60) Provisional application No. 60/975,723, filed on Sep. 27, 2007.

(51) Int. Cl. F16G 11/00; B32B 7/04; B23K 11/00

(52) U.S. Cl. 403/404; 428/120; 219/117.1

(57) ABSTRACT

A hybrid joint of dissimilar materials capable of bearing structural loads without long term creep due to a fiber stack in direct bearing of shear pins, studs, or legs on the lateral surfaces of multitudes of high-modulus fibers. The shear pins, studs, or legs may be welded onto a metal member and precisely incorporated into the composite during textile assembly prior to resin infusion and cure.

### CROSS-REFERENCE TO RELATED APPLICATIONS

This application claims priority from provisional application Ser. No. 60/975,723, filed Sep. 27, 2007, the disclosure of which is hereby incorporated by reference.

### TECHNICAL FIELD

An embodiment of the present invention relates to primary structural joints between dissimilar materials such as solid polymer-matrix-composite members joined to metal members using multiple intermediate metal components, and more particularly a method of joint fabrication that provides direct bearing between high-modulus fibers and metal studs, with the result that the joint transfers the full load bearing capacity between the composite and the metal member in both tension and compression with minimum strain.

### BACKGROUND

The use of polymer-matrix-composites (PMC) with steel in primary structures such as marine, aerospace, automotive, and buildings is limited because hybrid joints cannot transfer sufficient loads, or carry the loading for extended periods of time measured in decades without deformation leading to creep failure. The two criteria, first, stiffness under stress within the elastic range and, second, long term resistance to deformation at that stress level define a robust structural material or a robust structural joint.

For the purposes of this disclosure the term “primary structure” may mean a substantial, dense, solid, load-carrying component essential to the integrity and stability of a skeleton or frame able to successfully communicate stresses without long term deformation whether the member is composite or metal. Structural composites use multiple layers of solid, dense, bias-varied, high-modulus fiber fabric in an epoxy or high-strength polymer matrix. Stressed skin materials such as foam or celled cored panels and their joints are excluded since they are not dense, solid, or supportive of a skeleton or frame.

Current hybrid joining techniques do not meet the twin structural criteria. Each material, metal or PMC has inherent joining characteristics that conflict with the other. Mechanical fasteners are successful in metal to metal structural connections. But for hybrid composite to metal connections, the compressive nature of mechanical fasteners such as bolts or rivets loosen due to their native attribute of concentrating compressive stress beyond the composites local resistance to long term deformation. Adhesives are not well suited to carrying structural loads because their attribute is to join surfaces, and their surface adhesion is only a fraction of the load carrying capacity of a structural member. Welding is impractical for hybrid joints since most polymer matrix composites ignite at modest temperatures. The missing element is an intermediary between the metal and the composite that would be stiff and unyielding over time.

In the prior art when faced with joining cured composite sections and alloy members, the easy and obvious solution was to drill holes in the cured composite section for the insertion of a variety of metal fasteners including bolts, rivets, and pins. Pins with and without cap plates have been used without achieving structural load transfer levels, as disclosed by the users themselves. Holes drilled for the insertion of fasteners reduce the load carrying capacity of the composite, and provide a reliance on pin to polymer-matrix bearing, thus reducing the potential for stress transfer through the joint. The reason for the reduce potential is that the polymer-matrix has less load carrying capacity than the fibers. The failure mechanism of a joint based on drilled holes for pins is that these pins bear against only a few individual fibers or severed fiber ends. Imposed loads tend to break these fibers in sequence one after another until the entire joint is destroyed. These joints do create contact with fibers, but only a few undisturbed, continuous fibers are addressed in direct immediate lateral contact bearing, and these few fibers communicate their bearing stress to other fibers by way of the polymer matrix. Because drilled joints rely on the polymer matrix to communicate bearing stress they cannot avoid long term deformation even though the stress level is within the elastic range of the polymer material. The allowable stress on a typical polymer may be less than 10 ksi while the fiber may be utilized at more than 20 times that level. In the prior art since the attractive attribute of composites is their tensile ability, it is clearly counterproductive to rely on PMCs for their resistance to compressive stress.

In the prior art, co-bonded inter-laminar reinforcement in the Z direction for fiber reinforced polymer composites is known using a variety of pins and fibers within a member's cross-section. Materials with delamination tendencies typically are stressed-skin panels or highly-stressed built up layers of textiles or mats in XY directions. The name Z comes from the need to prevent delamination of these XY layers by the addition of reinforcing in the other or Z direction by the addition of fibers or pins. Thus, pins for Z reinforcing are well known in the prior art although the practical aspects of manufacture have been elusive. Typical fabrication techniques include drilling holes in a cured composite member for pin insertion, co-bonding of fibers, high temperature melt/burn insertion, or impact insertion by hammer or explosive with the result that fabric fibers are cut, burned, or severed.

Because stressed-skin assemblies inherently have delamination problems, Z pins have received much attention as inter-laminar reinforcement. In the prior art, Z pins for stressed skin assemblies have been extended and welded to facing metal skins as a hybrid joint. Such a joint is utilitarian but incapable of application to primary structures as is documented in the prior art. The load carrying capacity per pin is low, and impact driven pins rely on cell and polymer bearing and thus tend to deform over time. Furthermore driven pins appear to be a deficient method of reinforcing a hybrid joint.

In the prior art, a reliance on metal to fiber contact was considered in theory and practice to be an opportunity for fiber breakage. The breakage mechanism was assumed to be due to the normal roughness of even polished metal surfaces that possess micro filaments or metal barbs with the capability to instigate molecular separation in a high-strength fiber under tension when in lateral contact. Currently glass and carbon fibers used in metal matrix composites are typically coated to prevent such intrusive cleavage.

### BRIEF SUMMARY

In order to overcome the deficiencies in the prior art, the disclosure is, briefly stated, a hybrid joint of dissimilar materials capable of bearing structural loads without long term creep due to direct bearing of shear pins, studs, or legs on the lateral surfaces of multitudes of high-modulus fibers within a Fiber Bearing Block (FBB). The shear pins, studs, or legs may be welded onto a metal member and precisely incorporated into the composite during textile assembly prior to resin infusion and cure.

According to an aspect of the present invention, a fiber bearing stack of high-modulus continuous fibers within the warp or weft of a woven fabric may be provided. The fiber bearing stack may include direct contact fibers partially conformed around and in direct compressive lateral contact for less than one quarter of a circumference of a generally cylindrically metal shear stud; and direct bearing fibers layered upon the direct contact fibers, each fiber communicating direct compressive bearing stresses to subsequent layers. The fiber bearing stack communicates and converts all direct metal-to-fiber compressive bearing stresses into tension stresses along continuous lengths of the fiber bearing stack without permanent deformation.

The foregoing and other aspects will become apparent from the following detailed description when considered in conjunction with the accompanying drawing figures.

### BRIEF DESCRIPTION OF THE DRAWINGS

FIG. 1 is an enlarged plan view of a stud impaled fabric according to the teaching of this invention.

FIG. 2 is an enlarged cross-section of a stud and fabric contact interaction.

FIG. 2a is an enlarged section through a FBB.

FIG. 2b is a detail of FIG. 2 with the addition of indicators of stress interactions.

FIG. 3 is a perspective view of a double lap-joint.

FIG. 4 is a plot of test data on a load/train diagram.

FIG. 5 is vector diagram of straight and bias layers acting on an enlarged stud cross-section.

### DETAILED DESCRIPTION

As noted above, in order to overcome the deficiencies in the prior art, an embodiment of the current invention is briefly stated a hybrid joint of dissimilar materials capable of bearing structural loads without long term creep due to a resin-avoided fiber bearing block in direct bearing of shear pins, studs, or legs on the lateral surfaces of multitudes of high-modulus fibers. The shear pins, studs, or legs may be welded onto a metal member and precisely incorporated into the composite during textile assembly prior to resin infusion and cure.

One embodiment of the current invention is as a fiber bearing block of high-modulus continuous fibers within the warp or weft of a woven fabric comprising two categories of fibers. First, direct contact fibers are partially conformed around and in direct compressive lateral contact for less than one quarter of a circumference of a generally cylindrically metal shear stud. Second, direct bearing fibers layered upon the direct contact fibers, each fiber communicating direct compressive bearing stresses to subsequent layers. The result is that the fiber bearing block communicates and converts all direct metal-to-fiber compressive bearing stresses into tension stresses along continuous lengths of the fiber bearing stack without permanent deformation. In addition the fibers of the fiber bearing block due to intimate contact with the stud surface and each other remain dry without resin infill when the remainder of the woven fabric is infused with polymer matrix resin and cured to form a portion of a composite member. The direct bearing contact keeps the polymer from wetting the fibers and the fiber interstices with the stud. This enables fibers of the fiber bearing block to communicate and distribute tension stresses to the remaining fabric and resin throughout composite member.

This teaching of an embodiment of the current invention is in contradiction with the understanding and practice in the prior art avoids fiber breakage due to direct metal to fiber contact since this embodiment goes past contact to teach the benefits of direct metal to fiber bearing. This teaching of the embodiment of the current invention is in contradiction of the prior art that incorporated fasteners after a composite section was assembled and cured and then experienced loosening of fasteners due to polymer creep. This embodiment of the current invention may be contradictory to the teaching of the prior art where compressive loads on composites were to be avoided or moderated to a stress level below 20% of matrix allowable since the polymer matrix portion of the composite experienced permanent deformation due to long-term compression. The teaching of the embodiment of the current invention may be contrary to the teaching of the prior art in that compressive bearing stresses can be converted into tension stresses by a device and mechanism internal to a cured composite. The teaching of the disclosure is contrary to the teaching of the prior art since the prior art of PMCs emphasizes the necessity for complete resin infusion, and this disclosure teaches that the judicial design and avoidance of resin infusion can return substantial rewards for bearing loads for structural hybrid joints.

Structural welded studs were developed by the Navy in the early part of the last century for joining timber to structural steel. Since then the application of studs has been extended to the joining of concrete and ceramics to steel. With the development of capacitor discharge guns, pins as small as 2 mm can be directly welded to a like parent metal.

The joining method of the disclosure may be straightforward. First, pins may be stud welded to the structural member. Their length may be selected to equal or exceed the thickness of the panel to be joined. Then thin layers of textile or mat of either raw or minimally previously resin impregnated fiber may be pressed over and impaled on the pins. Then the layers may be infused and adhered with resin. The assembly may be vacuum bagged to fully impregnate and infuse the layers and eliminate any air. The exception to this infusion is the FBB which remains internally dry and un-infused with resin due to close and intimate contact with other fibers. This FBB represents only a small dimensional length and portion of the continuous fibers that are within the FBB. Then the composite is cured as a completed hybrid joint.

An embodiment of the current invention may create a joint with a variety of structural metals, including various alloys of stainless steel, mild and alloy steel, and aluminum. This joining method may incorporate any of these materials and any other metallic that can support welding. The joint may incorporate a variety of fibers including various glasses, aramids, and carbons, natural and synthetic fibers.

An embodiment of the current invention may utilize a variety of deformed and smooth studs and pins available in many cross-sections, configurations, and lengths. Studs are available for both capacitor discharge and welding power supply designs. In most cases, a stud will be the same material as the native plate or shape. Thus, the weld-compatibility issue between metals is alleviated. The welding process used may be an automatic shop process that rolls down the length of a structural member or attachment strip and with automatic stud feed progressively spot-welding each row of studs. Such a metal attachment strip may then be attached to primary structural members in the field by typical metal joining methods such as welding, bolting, or riveting.

Transfer depth: An embodiment of the current invention teaches that to achieve full load transfer with high-strength steels, a double lap-joint may be indicated in which the composite may be built up on the two faces of the steel member. The number of studs required for a joint may be the loading divided by the allowable loading per stud. The length of the lapped portion of a double lap-joint may be determined by dividing half the loading per unit width by the allowable loading of one stud times the diameter of the area required for one stud. The area required for one stud is determined by the distance between undisturbed and un-displaced weaves being generally four times the depth of the weave either warp or weft in any direction.

Stud strength: The strength of the stud and its weld to the base member may be related to its diameter. The stud weld must be strong enough to resist the total bearing shear generated along the stud's length by the direct fiber bearing. The stud must be strong enough to provide two-axis stability during penetration to prevent fold-over during fabrication. The stud must be long enough to penetrate at least the full thickness of the composite. The stud must be strong enough in shear to communicate the total load from the FBBs to the weld.

Textiles: Textiles may be woven with precise rectilinear topography, dimensions, and fiber count per tow. The topographic precision may be represented in that the warp and the weft are generally orthogonal especially with high modulus fiber because of the fiber stiffness. An embodiment of the current invention teaches that woven textile precision of manufacture may be used to select and specify the diameter and coordinate placement of metal studs welded to a metal member to predict the allowable stress transfer in direct bearing between the fiber and metal stud. This embodiment further teaches that the micro examination of the direct bearing of one stud may be statistically extendable for the predictable macro calculation of load transfer between structural composite and metal members in hybrid joints.

Stud Size An embodiment of the current invention teaches that for a given composite thickness and specified fabric the use of too large a stud may result in fiber breakage during impalement of the fabric due to the inherent stiffness of the fabric, and that the use of too small a stud may result in an inadequate number of fibers in the bearing stack which causes joint efficiency to suffer.

Woven fibers have limits on their extension to accommodate a stud. The inserted metal shear stud should not force more than a 4% increase in the displaced length of the contact fiber from the original as woven dimensional length. Since most woven textile have narrow warp and weft the diameter of the metal shear stud is limited to less than 0.2 inches in diameter.

An example of an embodiment of the current invention may be a hybrid double lap-joint may be made up of a single plate member partially face-lapped with two composite members or two extensions of one composite member where when the joint is subjected to an external load then portions of that load must be communicated across the planes of the lapped facing surfaces of composite and steel.

When an object such as a stud impales, spears, pierces, or skewers a woven fabric, it may displace fibers from their original position and it may tension them to various degrees depending upon the distance they are displaced. The tension may be a result of the stiffness and cohesion of the fabric.

It is accepted in the prior art that lateral bearing of fiber-on-fiber for most, if not all, high modulus fibers instigates no fiber breakage while in tension, otherwise fibers would not be used as twisted tow. Knitting yarn may be an example of twisted tow. An advantage of twisted tow is that even if one fiber is discontinuous or breaks, the remaining fibers may cooperate to communicate the total tow load through the twisted fibers because they may be constrained to transfer the load fiber-to-fiber. This has two implications for the embodiment of this current invention. First, fibers in the fiber bearing block, although not twisted, may be bound by polymer matrix into a similar constrained contact structure around the stud and, therefore, may tend to transfer loads to other fibers if one fiber breaks. Second, fibers in lateral bearing in a fiber bearing block, even without polymer matrix acting as a stress moderating material, may be capable of developing their full tensile capability because the fibers can normally engage in surface to surface contact while in tension without instigating breakage.

An embodiment of this invention teaches that fibers that are most displaced from their original woven position may possess a contact line with an impaled cylindrical object. This contact line arc may be advantageous for moderating fiber breakage due to its distribution of bearing stress. A string around a knife blade may be more likely to be severed than a string around a pen. Thus, under the teaching of this invention, when a tension loading is induced in a composite connected to a metal member, the contact fibers may receive the load directly from the metal stud. These direct contact fibers then might communicate that transverse bearing load to the adjacent fibers that are in close proximity and bearing contact within the FBB. The contact line of the direct contact fibers may aid them in communicating that compressive stress to the rest of the fiber bearing block, putting the entire fiber bearing block in generally equally high tension beyond the FBB, and thence communicating that loading to the entire composite member.

This invention uses direct compressive lateral bearing of high-modulus fibers void of matrix resin on a portion of the circumference of a metal section, stud, or pin in an intercessory function to communicate structural loadings from composite members to metallic alloy members.

For the purposes of this disclosure the term “direct bearing” refers to the stress transfer due to surface contact under a compressive load. This direct bearing may occur in two ways. First, direct bearing may occur between a portion of the circumferential area of a stud and the longitudinal fiber contact area of fibers most displaced within the fabric. Second, direct bearing may occur between fibers within the FBB.

High strength fiber fabrics and textiles are a manufactured assembly of fibers and/or yarns that have substantial surface area in relation to their thickness and sufficient cohesion to give the assembly useful mechanical strength to resist distortion. In the typical basket weave pattern the warp, the lengthways threads, and the interlacing weft, the width ways threads provide this two dimensional cohesion. This cohesion may provide tensioned restraint to impalement by an object such as a stud.

It may be common practice that a high modulus woven textile is made up of flattened tow in warp and weft. Pressure flattening during impalement may be used to allow layered stacking in thin composite sheets and sections for efficient use of the materials. Since each tow may be pinched by the basket weave pattern, the woven tow may tend to be thinner at the outside. The impalement of a needle in the textile at the intersections of warp and woof may displaces no fiber. Thus there may be a minimum diameter to create multiple fiber direct bearing. If the stud is too large, (1) some fibers may be broken, and (2) the fabric may be distorted and thickened creating layup problems. An embodiment of this invention teaches that the demanded elongation of the contact fibers due to impalement should generally not exceed 3.5% with 4% as a limit. This elongation ratio may be specified rather than a ratio between the stud diameter and the warp or weft width because different fabric weaves change the constraint of the fabric. For example, crowfoot and eight harness may be much less constrictive than a plain basket weave allowing the fibers to be displaced at a more acute angle reducing forced fiber elongation for the same warp/weft width and stud combination.

The stud gauge may be the distance between studs. For the purposes of the embodiment of this invention the metal studs act in cantilever action, collecting shear stress along their length and communicating that total shear stress thru the weldment to a metal member.

For the purposes of this invention, substantial direct bearing means that more than 10% of the fibers in either a warp or weft displaced from their rectilinear pattern by the impalement of a stud may be displaced into a fiber bearing block that is in lateral bearing with that stud.

In the prior art of Z pins, a substantial number of very small Z pins was required to control inter-laminar shear due to their limited local benefit. In the prior art these Z pins were stress neutral except in the vertical direction. The resistance to delamination rested solely on the bond stress of the pin to polymer matrix. Thus the prior art Z pin tendency toward small pins and even individual fibers made them difficult to orient for the fabrication and co-bonding. For an embodiment of this current invention, the metal member provides orientation for a multitude of studs due to their regular welding pattern as a mandrel or fixed template on the supporting metal member. This regular pattern imposed by the stud welding in the early fabrication sequence may provide the opportunity for automated welding and semi-automated impalement of fiber layers.

In each of the following drawings a line is used to be schematically representative of a group of fibers since individual fibers are far too small to be shown at the scales required.

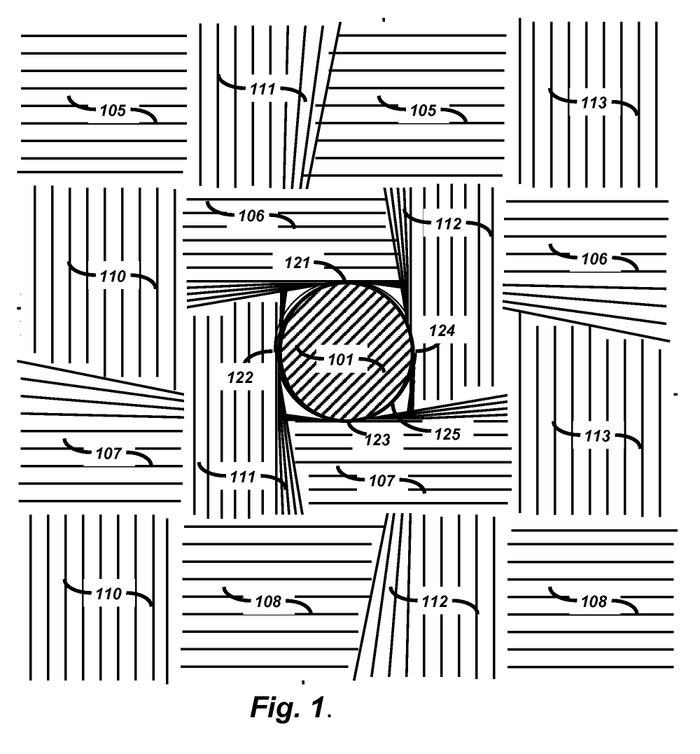

FIG. 1 shows the basket weave pattern of a fabric made of high modulus fibers. The fibers within the weft 106-107 and the warp 111-112 are affected by the insertion of the stud 101. The fibers of weft 106 are displaced and wrapped around a small portion of stud 101 to form a FBB 121. In like manner FBB 122-124 are formed. Another beneficial effect due to impalement spreading the weave is shown in the vacant corners around the stud 101. These vacant corners provide a void between the layers where bias fabric can form FBBs without needlessly thickening the layers of fabric. One example of the four corner opening is indicated at 125. In the same way the bias fabric provides room for the FBB 121-124 of this layer of fabric.

For efficient use of material under uni-directional loads the warp and weft of said woven fabric are equal in width dimension and number of fibers. For further efficient use of materials special widths of warp and weft may be specified when alternate layers of woven fabric are positioned at a 45 degree bias.

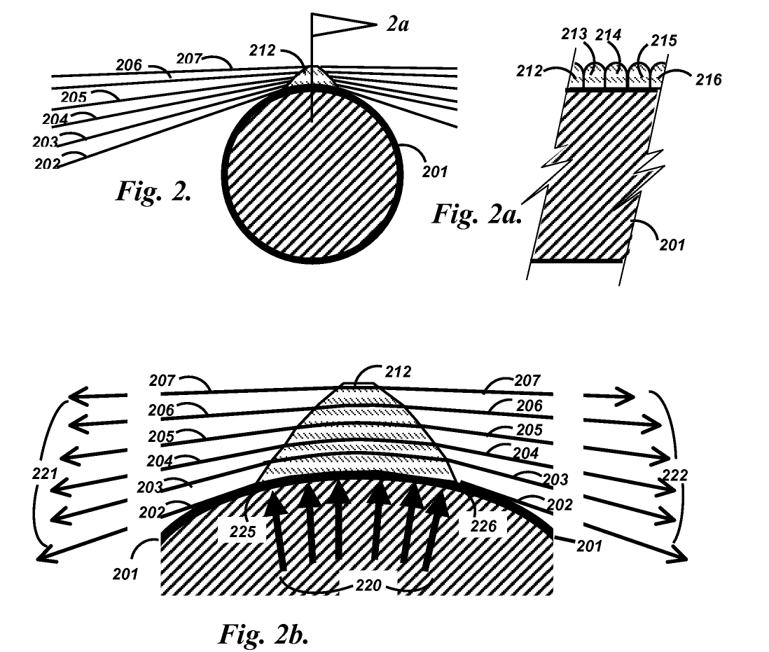

FIG. 2 shows how the contact fiber 202 is in tangential contact to wrap around stud 201. Other displaced fibers 203-207 are forced to bear on the direct contact fiber 202 and with each other. The FBB 112 is generally solid compressive bearing block where the fibers 203-207 are in such intimate contact that they remain internally dry from resin despite vacuum infusion.

FIG. 2a shows how multiple layers of fabric form FBBs 212-216 nest together to form a Fiber Bearing Stack (FBS) of internally dry, unsaturated fibers in direct bearing with the stud 201 along its lengthwise surface.

FIG. 2b shows the fiber 202 being forced by the insertion of the stud 201 to a tangential position at 225 and 226 in direct contact with the stud 201. The fiber 202 bears on the arc surface of the stud 201 for the circumferential surface distance from 225 to 226. Fiber 203 is then forced to a displaced position in direct bearing on top of fiber 202. Because of the slightly different point of origin within the textile, fiber 203 has a slightly smaller arc of contact with fiber 202 that fiber 202 had with the stud 201. In like manner to fiber 203, fibers 204-207 are caused to overlay previous structure in sequence to form a dense FBB. The detail shows that during infusion of the polymer resin matrix the resin has relatively easy access between the fibers 202-207, but not within the FBB 212 because of the density and intimacy of contact within the FBB 212.

That intimate contact under loading increases positional restraint of the FBB. The direct bearing stresses of the fiber bearing block on the stud generate frictional restrain from delamination separation between the fabric layers of the cured composite under external loadings.

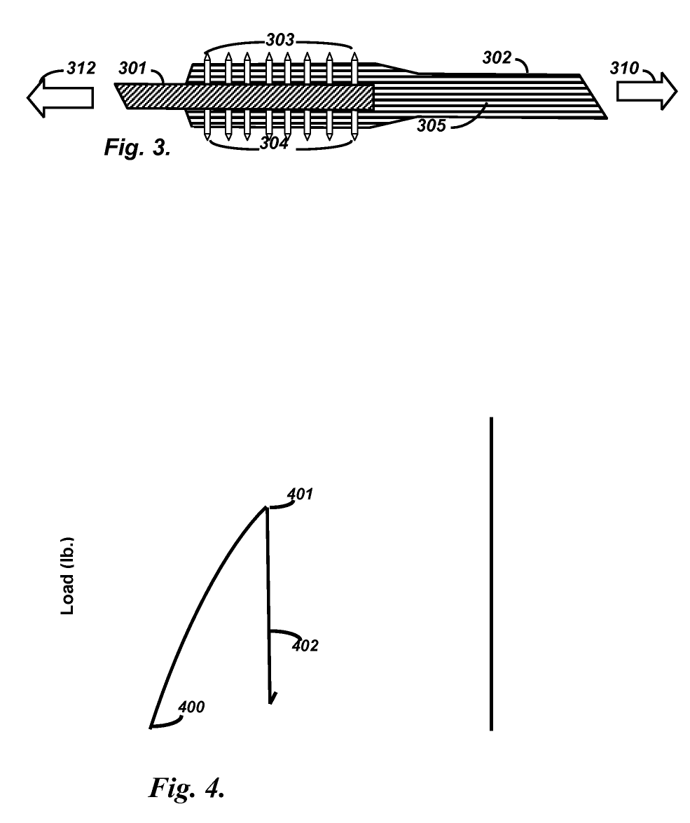

In FIG. 3 a double lap-joint is shown resisting tension loads externally induced at 310 and 312. The hybrid joint consists of a metal plate 301 that has shear studs 303 welded to the upper face and other shear studs 304 welded to the opposing face. These shear studs 303 & 304 are provided with points to ease their penetration of fabric during assembly. A composite member 302 is co-bonded onto the two faces of the metal plate 301. The description of the FBB exception to this co-bonding is described in FIG. 2a. Multiple layers of reinforcing cloth 305 are shown as having been placed in linear layers parallel to the faces of the metal plate 301.

FIG. 4 shows the results of a tension test of a double lap-joint after the teaching of an embodiment of this invention. In the research leading to this embodiment various specimens were fabricated and tested. A representative double lap-joint was fabricated under the teaching of this embodiment and tension tested to failure. The 9 inch long steel plate member of the specimen was 3.0 in. wide×0.1 in. thick, resulting in a cross-sectional area of 0.3 in². Eight studs each 3.8 mm in diameter, equally spaced in a nine square inch area were welded to each face at one end of the plate. E-glass of 24 oz per square yard was used to build up a section of equal thickness to the steel. E-glass layers of fabric on either side of the metal plate consisted of two fabric plies, rotated 45°, sandwiched between fabric plies which had the warp direction aligned with the axis of the sample. These dry layers were randomly impaled on each individual stud. Each stud displaced approximately 40% of the fibers in each warp or weft to either side into fiber bearing blocks. Each FBB was displaced at an observed angle of about 15 degrees by the stud in relation to the weave. The joint was then vacuum infused with resin and age cured.

FIG. 4 shows the tension test had generally linear elastic characteristics 400-401 until the joint failed 401 at 12,980 pounds due to simultaneous failure of the stud welds 402. No permanent deformation was observed throughout the elastic range of the test 400-401. This may be evidence that long term loads within the elastic range of the FBB need not experience deformation or creep failure. The 811 pounds of shear on each of the 16 studs was communicated to the studs through the seven fiber bearing blocks in the five weft layers. These fiber bearing blocks all acted in compression opposing the tension loading. This indicates that the specimen could have been subjected to opposing compression with the same effect. The bias layers contributed two FBBs each although their compression contributions were devalued 29% by their 45 degree bias vector. The contributions of the five layers produced a multiplier of 5.8 times the bearing capacity of one FBB. The FBBs produced a Young's Modulus of about one million psi/inch at joint failure being stud weld limited.

Thus one embodiment of the current invention is as a structural hybrid double lap-joint comprising two dissimilar members. First, is a metal structural member possessing on opposing faces a selected plurality of orthogonal, regularly spaced, metal shear pins. These shear pins are generally co-bonded with a second member a composite where the pins penetrate through, displace, and place in direct bearing a multiplicity of high modulus fibers devoid of resin in fiber bearing blocks in a plurality of woven layers. The composite is encased for a thickness of an attached portion of a structural polymer matrix composite member. The result is stresses are transferred from said metal member to said metal shear pins, then to the fiber bearing blocks, and then to the composite member for load transfer equal to the lesser allowable structural capability of either metal or composite member. The result is a robust, stiff joint whereby when the joint is loaded to the point of tensile failure the joint produces less than 0.02 inches of strain displacement, and joint deformation per unit of time is linear when continuously loaded to the lesser allowable structural capability of the two members for two years.

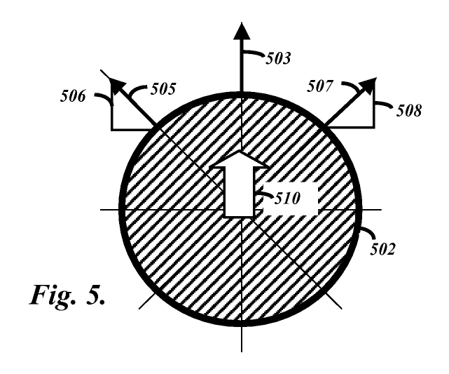

FIG. 5 shows a schematic cross-section of a shear stud 501 with a center at 502 and an induced force 510 acting transverse to the stud 501. The vector 503 is representative of a parallel layer and the vectors 505 and 507 are representative of a bias layer. The stud force 510 produces a component force 503 that is representative of the resistance of a FBB acting local to the polar region by the parallel layer. The force arrow 503 is resisted by a tension arrow 504 representative of the tension induced in a fiber layer by the compression on a FBB. In like manner force arrows 505 and 507 are resisted by tension arrow 506 and 508 representative of the tension induced in a fiber of a bias oriented fabric layer by the compression on their respective FBB. Because force vectors 505 and 507 are inclined at 45 degrees due to their bias layer they only contribute about 70 percent of their vector to the polar direction of the stud force 510. However, the two vectors 507 and 505 of a bias layer together contribute 1.4 times the non-bias layer vector 503.

An embodiment of the current invention is a method of strengthening a hybrid composite joint, employing the operations of providing a first metal member; providing a second member being a plurality of metal studs welded to the first member; providing a third member of layered fabric material; applying and impaling the third member by layers over ends of the second members and onto the second member, the second members being so positioned and arranged such that fibers displaced from their woven position within the layered fabric material form fiber bearing blocks that when the joint is co-bonded with polymer matrix, remain devoid of resin to communicate both tensile and compressive stresses from the first member to the third member without permanent deformation.

Although embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A fiber bearing block of high-modulus continuous fibers within the warp or weft of a woven fabric comprising:
Direct contact fibers partially conformed around and in direct compressive lateral contact for less than one quarter of a circumference of a generally cylindrically metal shear stud; and
Direct bearing fibers layered upon the direct contact fibers, each fiber communicating direct compressive bearing stresses to subsequent layers,
Whereby said fiber bearing block communicates and converts all direct metal-to-fiber compressive bearing stresses into tension stresses along continuous lengths of the fiber bearing stack without permanent deformation.

2. The fiber bearing block of claim 1 whereby the fibers of said fiber bearing block due to intimate contact with the stud surface and each other remain dry without resin infill when the remainder of the woven fabric is infused with polymer matrix resin and cured to form a portion of a composite member.

3. The fiber bearing block of claim 1 whereby said fibers of said fiber bearing block communicate and distribute said tension stresses to the remaining fabric and resin throughout said composite member.

4. The fiber bearing block of claim 1 whereby a diameter of inserted metal shear stud force is less than a 4% increase in the displaced length of the contact fiber from the original as woven dimensional length.

5. The fiber bearing block of claim 1 whereby the diameter of the metal shear stud is less than 0.2 inches in diameter.

6. The fiber bearing block of claim 1 whereby the warp and weft of said woven fabric are equal in width dimension and number of fibers.

7. The fiber bearing block of claim 2 whereby alternate layers of said woven fabric are positioned at a 45 degree bias.

8. The fiber bearing block of claim 2 whereby the direct bearing stresses of the fiber bearing block on the stud generate frictional restrain from delamination separation between the fabric layers of the cured composite under external loadings.

9. A structural hybrid double lap-joint comprising:
A metal structural member possessing on opposing faces a selected plurality of orthogonal, regularly spaced, metal shear pins penetrated through, displacing, and placing in direct bearing a multiplicity of high modulus fibers devoid of resin in fiber bearing blocks in a plurality of woven layers that are encased for a thickness of an attached portion of a structural polymer matrix composite member, whereby stresses are transferred from said metal member to said metal shear pins, then to the fiber bearing blocks, and then to the composite member for load transfer equal to the lesser allowable structural capability of either metal or composite member.

10. The structural hybrid double lap-joint of claim 9 whereby when the joint is loaded to the point of tensile failure the joint produces less than 0.02 inches of strain displacement.

11. The structural hybrid double lap-joint of claim 9 whereby joint deformation per unit of time is linear when continuously loaded to said lesser allowable structural capability of the two members for two years.

12. A method of strengthening a hybrid composite joint, comprising the operations of:
providing a first metal member; providing a second member being a plurality of metal studs welded to the first member; providing a third member of layered fabric material; applying and impaling the third member by layers over ends of the second members and onto the second member, the second members being so positioned and arranged such that fibers displaced from their woven position within the layered fabric material form fiber bearing blocks that when the joint is co-bonded with polymer matrix, remain devoid of resin to communicate both tensile and compressive stresses from the first member to the third member without permanent deformation.
